(19) United States
(12) Patent Application Publication
(10) Pub. No.: US 2014/0290027 A1
(43) Pub. Date: Oct. 2, 2014

(54) METHOD AND A SYSTEM FOR THE FABRICATION AND/OR ASSEMBLY OF PIPE

(71) Applicant: José Antonio de Souza Filho, Camasari (BR)

(72) Inventor: José Antonio de Souza Filho, Camasari (BR)

(73) Assignee: VOGA TECNOLOGIA E PROJETOS LTDA EPP, Lauro de Freitas, BA (BR)

(21) Appl. No.: 14/232,179

(22) PCT Filed: Jul. 13, 2012
(86) PCT No.: PCT/BR2012/000237

§ 371 Date: Mar. 14, 2014

(30) Foreign Application Priority Data
Jul. 13, 2011 (BR) PI1103435-1
Jun. 15, 2012 (BR) 102012014738-6

(51) Int. Cl. F16L 1/036

(52) U.S. Cl. CPC F16L 1/036
USPC 29/428; 29/700

(57) ABSTRACT

The present invention has the objective of providing a method and a system for carrying out the construction, fabrication and assembly of industrial pipe, at installations that have, as a characteristic, long straight pipe lengths, including the following activities, carried out at the factory: fabrication of tubes or pipe lengths with equal dimensions (standardized), assembly and welding of the pipe supports at their definitive positions, installation of steam tracer, heat insulation and fabrication of three-dimensional spools without clearances for adjustments. The method and the system also include assembly guides, devices for hoisting loads of tubes with heat insulation, modular coverings with coupled accesses and passageways, support bases for the adjustable pipe, a method of unloading pipe lengths or tubes in the industrial area directly at their definitive assembly place, as determined in the engineering project, the main advantage being the reduction of the total period of the undertaking and of the overall cost of construction, fabrication and assembly of industrial pipe.

The present invention relates to a method and a system for carrying out construction, fabrication and assembly of industrial pipe, markedly on pipe ways, pipe racks or other installations that have, a characteristic, long straight pipe, including the following activities carried out in factories or at another place, before assembly the pipe at their definitive places: fabrication of pipe or tube lengths with equal dimensions (standardized), multiple of the distance between pipe support points, preparation of their ends, assembling and welding pipe supports in their definitive positions, installation of heating steam tracers, heat insulation and fabrication of three-dimensional spools without clearance for adjustment.

The method and the system may further include assembly guides, tube-load raising devices with heat insulation, modular covers with coupled access and passageways, adjustable pipe support bases, unloading method in the industrial area of the pipe directly from the transportation equipment to its definitive assembly place, according to determination of the engineering project, a visual identification system of the pipe to facilitate the assembly, template installation between chamfers of the tubes to guarantee and maintain the distance required between the pieces, and a device that enables unloading of the spools directly at their definitive assembly place in a structurally balanced condition, having, as main advantage, the reduction of the total term of the undertaking and of the global cost of construction, fabrication and assembly of industrial pipe.

### DESCRIPTION OF THE PRIOR ART

At present the engineering execution project of industrial pipe and of civil constructions that serve as support points for the pipe are developed until a determined stage of its preparation, so as to provide the minimum instructions for the start of the civil construction and of the fabrication of pipe pieces, usually at factory, and subsequent assembly at their definitive place at the industrial unit for which they are intended.

The execution project, the civil construction of the support points of the pipe, called sleepers in the case of pipe ways, or beams in the case of pipe racks, usually built from concrete, and the fabrication and assembly of industrial pipe take into consideration the use of tubes or pipe lengths having varying lengths, as supplied by factories of tubes. In this scenery, the occurrence of great variations in length of these parts is quite common, and the pipe supports welded on the tubes are assembled and welded in the field (physical area of the industrial unit), one by one, after the pipe has been assembled and welded at its definitive place.

Besides, the pipe pieces that have curves, T-curves, reductions, flanges and/or other pipe accessories called spools, are conceived by the execution engineering to be fabricationed and carried to the field on a two-dimensional form, on trucks or semitrailer 12 meters long at most.

An additional length is often provided with at one of the ends of these pieces, so as to provide the necessary field adjustments. This additional length is required because the support points of the supports that are welded onto the pipe are fixed (not adjustable) and subjected to the construction tolerances of these structures, both in terms of coordinates and in terms of elevations, and the need for the pipe assembly to be finely carried out in conformity with the engineering execution project.

The time that passes between the beginning of the engineering execution project relating to details and the effective beginning of the pipe fabrication and assembly services at the present-day state of the art is too long, causing a negative impact on the total deadlines for carrying out undertakings in general, since the completion of the pipe systems is usually a critical way to the operation of industrial unites.

In addition, engineering execution projects usually do not consider methodologies directed to the best constructive practices, which chiefly aim at reducing services within the industrial units. Such a tendency raises the pipe-assembly costs too much, due to logistic issues, to some aspects of the assembling procedures employed at present, demands of labor unions, supplemental payment for danger-offering services, administrative demands of the owner, impact by rains and consequences thereof, and industrial safety, which will be explained hereinafter.

The distances involved in the facilities are longer and longer due to the growing size of the industrial units (and may reach at present the order of 8 km or more). This condition makes it difficult to transport and distribute the worker teams around the various work fronts, which are often very far from each other, thus contributing significantly to a partial loss of total working time.

The transportation of workers takes place, as a rule, in the beginning of the working hours (in the morning), while going to lunch and returning, and at the end of the working hours, which multiplies the losses with unproductive hours and renders the effectively worked hours (useful hours, or still productive hours) quite shorter than those that are paid to the workers. Moreover, the above costs are raised with the respective social charges and other costs associated by the assembling companies, which contribute to raising the total costs of these services.

The larger the number of working fronts that are developed simultaneously the more this situation will be aggravated.

However, the construction and assembly of the pipe follow initially the priorities of the released areas of the civil construction works, with approved pipe projects that have the necessary materials available, leading to a situation of spreading the tubes, pipe lengths and spools all over the area available for the assembly, even considering the best guidance for assembly planning.

In some cases, the owner himself of the industrial unit proposes in contract a planning of constructive activities based on operational systems (a set of elements and tubes that perform a single operational function) since the beginning of the construction an assembly, or permanently, which contributes to the existence of various construction and assembly fonts away from each other.

This combination of factors, that is, the distances involved and the way the programming of the services of construction, fabrication and assembly are conceived, end up causing dispersion of the working teams over the various working fronts, geographically far from each other. As a result the distribution of workers over the service fronts is made very difficult, and this cause a relevant damage to the effective performance of the supervision of field on the working teams, resulting in high rates of unproductiveness, contributing to the rise of the total costs of these services.

One more contribution to the high rates of unproductiveness, which has a strong relationship with said spread of the service fronts, lies in the logistics of distribution of tools and consumption materials like: electrodes, cutting and trimming discs and acetylene, oxygen bottles and acetylene, etc. Equally, the distribution and the positioning of welding machines, generators, forklifts and means of transportation for heavy load, at the time of distributing pipe pieces along the various assembly places and finally the displacement of the workers during the normal working hours (during the useful hours), in addition to the mentioned ones, which contribute, in conjunction, to the rise of the total costs.

All these movements of workers, materials, tools and equipment are made from different vehicles and machines, and their traffic is limited to low speeds (from 20 to 30 Km/h), considering the industrial safety requirements, which is an additionally aggravating factor because it increases the global time of the displacements and, as a result, the unproductive hours.

Another source of unproductiveness in carrying out the services of assembling pipe within industrial unites results from strike movements strike movements and other stoppages of working nature, which also end up reducing the total of hours effectively employed in assembling pipe (useful hours) in the field, which contribute to rising the total costs of these services.

A further significant source of unproductiveness lies in specializing the workers, which is required by the owners of the facilities and/or labor unions, wherein each worker only does the service of his specialty, instead of doing a multidisciplinary work. Thus, while a milling worker performs his activity, the rest of the team (plumbers, welding workers, blowtorch operators and helpers) remains inactive, awaiting the completion of this service, which also results in an excessive rise in the global cost of manufacturing and assembling pipe.

Further, one adds, as source of unproductiveness, other factors of less human control, such as the occurrence of rains and its consequences, lack of electric energy in the area and atmospheric discharges that of cause stoppage of service, partially in some situations and totally in most cases. These elements too cause an impact on the total cost of the services of assembling pipe carried out within the industrial unit.

Coupled with the impacts on the productivity of the services carried out in the field (within the industrial units) is a growing need for permanence of the pieces of equipment used for the assembly, which are an important part of the total cost of pipe assembly.

Among the pieces of equipment used for industrial assembly cited above, the load rising machines and the transportation equipment deserve attention, because they contribute with most of these costs. Their permanence in the working place is prolonged by the reasons mentioned above, but also due to a number of factors related to the activities of storing the pieces and their transportation and distribution in the field.

At present, the storage of tubes or pipe lengths is carried out at random, without following an organization or any type of plane or programming that could make the loading of materials to the filed easier. For instance, tubes/pipe lengths that are to be assembled one beside the other are stored far from each other, without any organization logics with the position of the pieces in the field or at their places of permanent assembly. Obviously, such a behavior impairs the supplying activity and increases the costs with transportation and load raising, both in the loading at the storehouse and at the places of assembly in the field.

Thus, the more services are made at the industrial unit, the more the above-cited effects multiply and cause impact on the overall cost of manufacturing and assembling pipe.

At present, the services relating to the steps of manufacturing and assembling pipe of the type cited herein, which are made outside the industrial unit, that is, at factory, are limited to the pipe pieces that have accessories (curves, T-curves, reductions, flanges, and the like) called spools, the main characteristic of which is that of being on a single plane (two-dimensional). Such pieces usually have extra material, at least at one of their ends, for field adjustments that are required, in order to for the assembly to be made.

One also fabrications pipe lengths usually formed by welding two tubes together, with uniform length, received from the factory, so that the pipe pieces thus formed have varying lengths, besides a special treatment of their ends.

These lengths are spread in the area over their support points (sleepers), or in regions adjacent the assembly places, along the pipe ways or pipe racks, at times dozens of meters away, or even hundreds of meters away from their definitive assembly places, which play the role of a field storehouse.

At the support points of the pipe supports (sleepers), the several center lines of the pipe are marked by the topography team, where the tubes should be aligned at their definitive assembly place.

These markings are made with “little flags” that do not indicate which tubes will be assembled in these respective positions, or when they indicate, they are visible only from near, for which reason it is necessary to identify which tube/pipe length or spool should be assembled at a determined place. All these identifications and displacements of the pieces required for carrying out the assembly are made when the assembly team is awaiting (helpers, grinders, plumbers, welders, blow-torch operators and people in charge) or aiding in moving the pieces to their places of definitive assembly, which also contributes significantly to the total unproductiveness of the services.

Thus, the straight pipe lengths or spools are transported to their unloading places, field storehouse, within the industrial unit, through operations of successive lifting and horizontal displacements as far as the final position for coupling with the other tube or pipe length.

These movements of horizontal and vertical displacements of the pipe lengths, spools and supports from the unloading place close to the assembly area to their definitive position are considered responsible for at least 30% of the amount or resources necessary for the fabrication and assembly of pipe, raising considerably the total costs of these services.

During this operation, the pipe team, composed of plumbers, welders, blow-torch operators, grinders and helpers, are either involved in these displacements or are waiting for the piece to arrive close to its assembly place to begin working in coupling and welding them. This is a factor that contributes to an increased consumption of resources and to an increase in the global cost of the fabrication and assembly of pipe.

Besides, since these parts are unloaded out of the definitive assembly place, there is not enough room for unloading a larger volume of pipe lengths, tubes, spools and supports, which limits greatly operation of transporting and unloading these materials from the storehouse to the assembly place creates the need for longer residence time of equipment, for transporting and lifting the load. Additionally, the pipe lengths are unloaded one by one, which further reduces the global capacity of transportation and unloading that are traditionally adopted, which is one more factor that raises costs in the fabrication and assembly of pipe.

During the activities of adjusting the couplings, one verifies the compatibility of the two ends of tubes with the requirements of quality, in order to obtain a welding with the quality required by the applicable rules. It is normal to use successive operations of grinding (trimming) the chamfer of the pipe joint until the required adjustment is achieved, in addition to correction of oval deformations of the tubes, their planarity and of the perpendicularity of the drills, which causes loss of productivity because this service is carried out in the field (the area of the industrial unit). What one observes is that, during this operation, the plumbers, welders, blow-torch operators, assemblers and helpers involved in the service remain idle, waiting for these adjustments to be completed, which is another important factor that raises the total costs of pipe assembly.

The same waste occurs in the case of flanged or threaded ends, when the preparation of these ends is carried out in the field (area of the industrial unit).

At present no system is used to prevent or at least minimize this adjustment work in the field, so as to reduce the consumption of human resources (workers) in the services of assembling pipe in the field.

Besides, since the tubes or lengths have different sizes, their welds remain dispersed over the whole assembly area, causing a harmful spreading of the teams, making it difficult to supervise, protection of the coupling and welding places from rain, wind, sunshine and other bad weather conditions, further increasing: the use of assembling and welding equipment, the consumption of diesel oil for generators and welding machines, the amount of scaffoldings used for building provisional staircases and overpasses to provide safe access of the workers to the different service fronts.

In addition to the couplings and welding of the pipe pieces, there are also the repair of painting and the finish painting, installation of steam tracer, the application of heat insulation, the installation of supports and the removal of outstanding activities too are subject to the same harmful factors mentioned above. All of this increases the rates of unproductiveness and the overall cost of the fabrication and assembly of pipe.

The assembly of spools follows the same procedure described for straight pipe.

After the various tubes or pipe lengths and spools are welded and in their definitive assembly place, the pipe supports are installed and welded.

As is the case with tubes and lengths and spools, the pipe supports (which are welded on the respective outer surfaces of the tubes) are unloaded near the assembly place or at a distance of dozens and sometimes hundreds of meters. Like the other pieces, the supports are lifted and displaced horizontally, in successive movements, and even carried by the workers as far as their definitive assembly place, which causes the same waste mentioned above for straight lengths.

When the pipe is assembled and welded, it is raised with the aid of a load lifting machine, or a hydraulic jack, or a block-and-tackle device with a mini-portico, or even by hand with the aid of a lever, depending on the weight of the pipe. The support is installed beneath the pipe, which, after being adjusted at its definitive place, is released for welding, usually in a position of difficult access, which makes the welding more difficult, slower and consumes many human resources and equipment.

The assembly and welding of pipe supports are activities characterized also by spreading the working teams, causing the same problems of productivity mentioned above for straight lengths.

Thus, what is observed is a high consumption of resources for assembling the pipe supports in the field, which also contribute to raising the total costs of the services of assembling pipe or pipe racks.

Additionally, the pipe that have heat insulation, with or without steam tracer, have only their steam trace installed and are insulated in the field, after being definitively assembled and with their respective supports installed. Thus, these activities are equally subjected to harmful dynamics of the works carried out in the field, contributing to raise the global unproductiveness of the pipe assembly.

The pipe the is not heat-insulated need their painting system repaired and built after installation of the pipe supports, this operation also contributing to a great waste of resources, as in the case of the activities cited before.

Besides, the present-day procedure of manufacturing and assembling pipe is conducted in such a way that a large part of the outstanding constructive activities (removal of the assembling devices welded on the pipe, repairs in heat insulation, removal of weld points, adjustment of pipe supports and repairs of painting) are removed only at the end of the assembling work. Thus, there is great dispersion of labor in the field and high rate of unproductiveness.

It is important to point out also that the dispersion of activities of assembling pipe in the field described above makes it very difficult to supervise the teams, which has an impact on the execution of these services.

Even if the detailing engineering project is carried out in electronic mockup (three-dimensional), by using the most advanced software available on the market, there is not contribution in the prior art to the reduction of the amount of pipe services that are carried out at present in the area of the industrial unites.

This method and procedure of manufacturing and assembling pipe described above a representative of the prior art have been employed ever since the construction of the first oil refinery known in the world in 1851 in Bathgate, Scotland.

It is observed that the advances in the technique were restricted to the area of materials employed in manufacturing tubes, technology of the valves and in the welding technology.

Brazilian patent application PI 0800385-8 A2 brings an advance in the assembly area only for assembly of straight pipe lengths on pipe ways, based on systems that use a winch-and-roller assembly fixed to the support points of the pipe, so as to establish a work station, usually covered, wherein the couplings and the welding of pipe are carried out, and the pipe, as it is welded, is pulled by one of its ends by means of a winch with the aid of said rollers.

However, this method has, as a disadvantage, the fact that the services may only be productively started with the project in an advanced phase of physical execution (about 80%) or completed, and after the construction of the sleepers and after all the materials required for assembly and the work place are made available, which causes the beginning of the assembly of pipe to be delayed. As a result, the tendency is that completion is delayed, which leads to a total period for completion longer than that of the traditional method described before.

In addition, this method does not solve the problem of unproductiveness, due to the programming of the owners on the basis of the operational systems and to the spread of working teams in the activities of assembling supports, repairing and painting the pipe along with the installation of the steam tracer and heat insulation.

One further observes the growing pressure from companies for reduction of the total time of implantation of the undertakings, coupled with the reduction of overall costs. Thus, the importance of reducing the total time of construction, fabrication and assembly of the pipe on pipe ways or pipe racks, reducing the resources invested is evident, consequently reducing the direct and indirect total costs for the company responsible for these services and, as a result, for the owner of the industrial unit.

### OBJECTIVES OF THE INVENTION

The various methods, systems and procedures employed at present in carrying out the civil construction of the support points of pipe and in the fabrication and assembly of pipe at industrial units are conceived in such a way that most of the services is developed in the field, resulting in the intensive use of much labor and equipment. Thus, high rates of unproductiveness and, as a result, high direct and indirect costs result for the companies in manufacturing and assembling pipe. Besides, longer periods are required for carrying out the works. All of this causes a negative impact on the return of the investment for the owner of the industrial unit.

Usually, the activities of assembling pipe at industrial unites compose the critical way of an undertaking as a whole, so that the reduction of period for execution of these activities may contribute significantly to the reduction of the total period for completing them.

The method and the system of the present invention has the objective of reducing the period of execution of the undertakings, by reducing the time of construction, fabrication and assembly of the pipe at industrial units. As a result, one achieves anticipation of the start of fabrication of pipe lengths, with definitive supports assembled, even before the detailing project is started. One also reduces the overall costs of these services by decreasing the application of labor, markedly in the field (area of industrial unit), besides a strong rationalization by reducing the overall level of qualification of professionals required. This is due to the high standardization and specification of activities, by optimizing the use of equipment and the aggregated costs thereof, maximizing the services at factory and reducing significantly the assembly works in the field. The teams are then concentrated on their tasks, which facilitates the supervision and control of the services, drastically reducing the removal of executive outstanding activities, which results in overall rates of fabrication and assembly of pipe lower than 50% with respect to those observed in the practice of these services.

### SUMMARY OF THE INVENTION

The present invention relates to a method and a system for carrying out the construction, fabrication and assembly of industrial pipe, markedly on pipe ways, pipe-racks or other facilities that have as characteristics long pipe lengths, including the following activities carried out at factory, or prior to assembly of the pipe at the definitive place, fabrication of tubs or pipe lengths with equal dimensions (standardized), multiple of the distance between support points of the pipe, preparation of their ends, assembly and welding of the pipe supports in their definitive positions, installation of steam tracer, heat insulation, and fabrication of three-dimensional spools without clearances for adjustments.

The method and system may further include assembly guides, devices for lifting tube load with heat insulation, modular coverings with coupled accesses and passageways, support bases for the adjustable pipe, method of unloading in the industrial area the tubs or pipe lengths directly from the transportation equipment to their definitive place, as determined in the engineering project, a system of visual identification of the tubes and pipe lengths to facilitate the assembly, installation of templates between chamfers of the tubes or pipe lengths for guaranteeing and maintaining the distance between the pieces and devices that enable the unloading of spools directly at their places of definitive assembly in a structurally balanced condition.

### BRIEF DESCRIPTION OF THE DRAWINGS

These and other objectives, characteristics and advantages of the present invention will now become apparent by means of a detailed description, when taken in conjunction with the attached drawings, in which:

FIG. 1 is a perspective view presenting a stretch of a pipe way with straight lengths 11, loops 10 and taps 12;

FIG. 2 is a perspective view of the support points of the pipe 13, supports or loops 14 and supports of taps 16, distance between the support points 5, also presenting the lines of references of assembly of pipe lengths 15;

FIG. 3 presents the construction of the sleepers 13 with the use of templates 17 to guarantee accurate positioning of the rods 18, besides the provisional gutter 70 to facilitate the welding of the interconnections between pipe lengths;

FIG. 4 illustrates the installation of assembly guides 20 on the inserts 19 of the support points of the pipe 13, to obtain the exact alignments and spacing foreseen in the detailing project for the pipe 21;

FIG. 5 presents a pipe length 21 on supports with rollers 25, with its supports 27, illustrating the distance between supports 29, which should be equal to the distance between the support points of the pipe, and the supports close to the ends should be spaced from the pipe by half the distance 28 between the support points of the pipe and the ends of the pipe length 31;

FIG. 6 illustrates the assembly guides 20 of the pipe lengths 21, the assembly lines 70, the reference line for start of the assembly of pipe lengths 15, the direction of assembly B and C and the place 30 for location of the welding, cutting equipment, tools, bathrooms and drinking water;

FIG. 7A presents an example of a typical loop (prior art) of industrial pipe ways with the spools 40, 41, 42, 43, and 44;

FIG. 7B presents a model of a three-dimensional spool, proposed in the present invention, with its spools 45, 46 and 47;

FIG. 8 presents a modular system of movable covering 81, with its hoisting eyelets 80, with coupled passageway 82, having interconnection stairway 83 between the street and the passageway, to enable safe access of the workers to the welds to be carried out on the assembly and welding line;

FIG. 9 presents a device for hoisting insulated pipe lengths, composed of a lower frame 71 and an upper frame 70, connected by cables 73, and joined by screw 76, parts 71, besides engagement of the shoe 74 with the part 71, and an hoisting eyelet 75 welded to the part 70.

FIG. 10 presents the use of a template 95 to obtain a necessary root opening of the chamfer 97 and applying a flexible adhesive tape 96 all around the joint to be coupled and welded;

FIG. 11 presents various models of support of the pipe 102, applicable to loops and spools, wherein changes of levels and directions take place, made wholly from steel 100, or with the columns made from concrete 101, and a metallic upper beam 102, or totally made from concrete 103, with an adjusting device 104 and 105 for adjusting the support level of the pipe 21, through the clearance 106;

FIG. 12 presents a device 48B that has an articulated ring 50 joined through a screw 51 with two support bars 49, this assembly enabling the unloading of spools 46, 46 and 47 directly from the transportation equipment to its definitive assembly place;

FIG. 13 presents a variation of the previous device 48B for application to spools when they are in a vertical or inclined position, the joint remaining between them in the horizontal or almost in the horizontal position, the only difference of which lies in the fact that it has four parts 49.

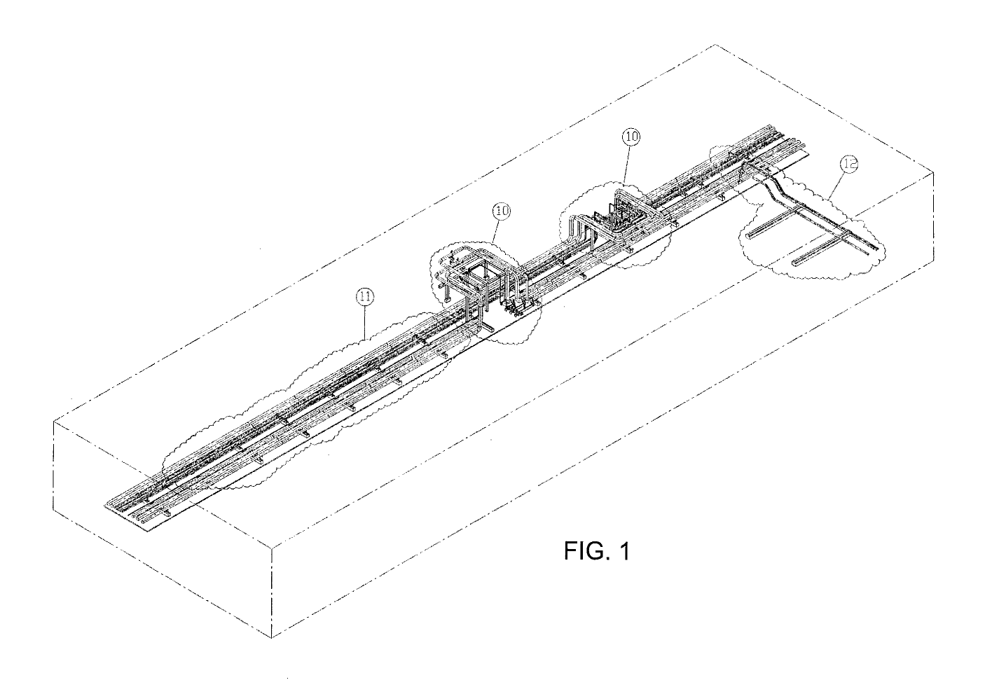

### DETAILED DESCRIPTION OF THE INVENTION

The method and the system for building, manufacturing and assembling pipe by pipe lengths or standardized tubes may be conceived regardless of whether the engineering execution project is drawn up or not. However, better results will be achieved when the decision for applying this method and system takes place before the beginning of the detailing engineering project. In this case, all the details of the project are conceived on the basis of the adopted standardization of pipe lengths or tubes, increasing the gains of the undertaking. This standardization of the length of tubes should have a dimension that is a multiple of the distance between the support points of the pipe. For instance, if the distance between the sleepers is of 6 meters, it is recommended to adopt a length that is a multiple of 6 meters.

Regardless of the phase in which the detailing engineering project is, the project team should inform how many pipe lengths should be fabricationed per material, diameter, thickness, painting system, inspection level, with and without steam tracer, type of heat insulation, as the case may be, and type of support. Such measures enable the acquisition of all the necessary materials and start of the services of manufacturing pipe lengths or tubes, including their definitive supports installed and welded, as soon as possible, with a view to reducing the total period of the undertaking. In other words, the start of the fabrication of pipe lengths, including their welded supports, may take place even if the detailing project does still does not exist, or in an initial phase thereof, which usually would not allow any fabrication activity. According to the present invention, with preliminary studies and with a consolidated list of lines, it is possible to anticipate the fabrication of pipe lengths or tubes, even without the project having been initiated, which contributes to reducing the total time of fabrication and assembly of pipe and, as a result, the total period of the undertaking.

The pipe lengths or tubes 21 with standardized length are then fabricationed with their supports 27 assembled and welded, undergoing the non-destructive inspections and examinations in order to guarantee the quality. The ends 31 are machined with a view to achieve better and faster coupiing at the time of assembly, already with the last coat of paint, steam tracer installed 77, heat insulations 78 completed, after which they are stocked in a storing area that should be quite large. The association of these procedures makes it feasible to stock a large number of pipe lengths, since the start of fabrication is anticipated, with a view to reduce the total period of the undertaking, and so that the for a stock of pipe lengths in the beginning of the assembly in the field will not impair the continuity of these services.

In other words, the work of assembling pipe is completed out of its definitive place, which entails the need to have an area sufficiently large for storing all the pipe pieces in an organized manner, providing rapid mobilization for transportation and assembly of pipe lengths at their definitive places.

It is noted that, since at the start of the fabrication of pipe lengths or standardized tubes is anticipated, all the pipe pieces may be manufactured with the same dimension, that is, of the same type, which enlarges the reduction of total cost by virtue of the high gain in scale achieved, without restrictions due to a programming of assembly of the pipe lengths.

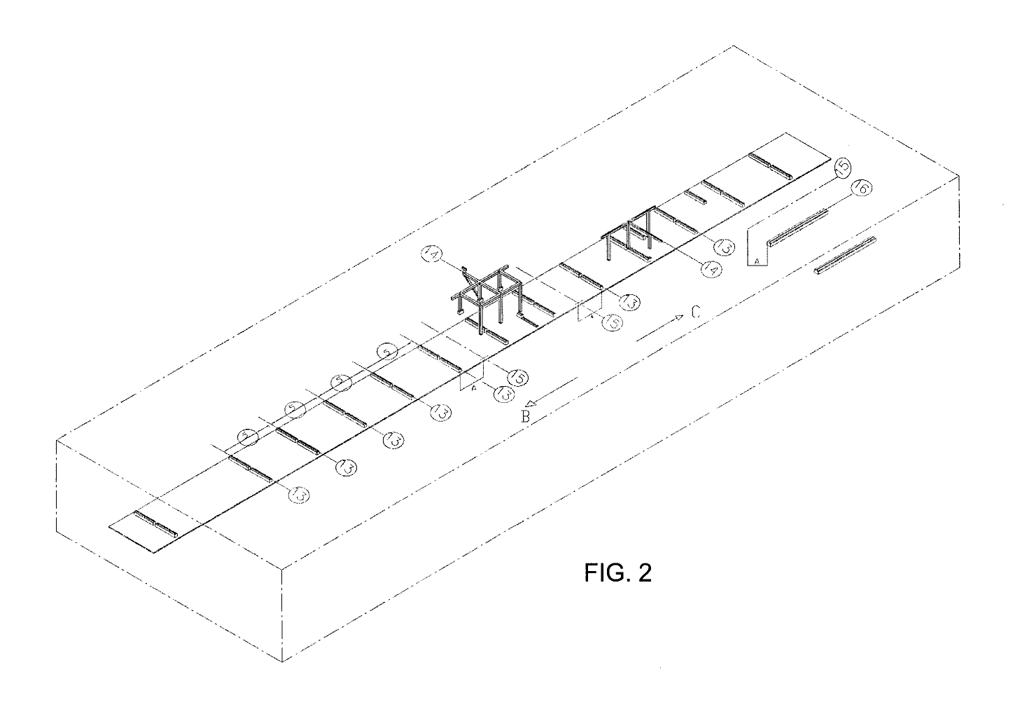

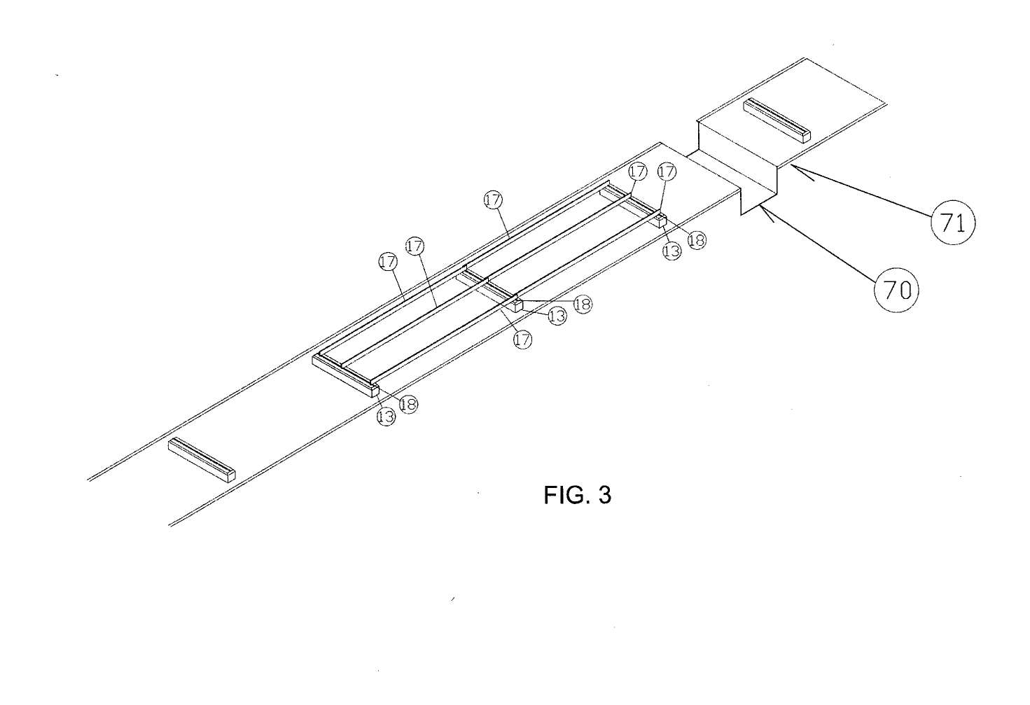

While the pipe lengths or tubes 21 are fabricationed and stored, the work in the field is carried out, with the construction of the sleepers 13 according to FIG. 3, which shows the use of templates for the perfect positioning of the sets of inserts 19 and rods 18, and the achievement of a standardized distance between the rods 5, FIG. 2, of two contiguous sleepers, according to the engineering project. In this way, the pipe lengths or tubes, and the position of the supports welded on them are standardized. By this procedure, any pipe length or rube with the same material, diameter, thickness, painting system, level of inspection, with or without steam tracer, type of heat insulation, as the case may be, as in the project for a determined pipe can be assembled between the sleepers, and their supports will always be perfectly positioned.

Special care should be taken regarding the perpendicularity with respect to the longitudinal axis when directing the pipe, the sleepers that are built initially, considered the sleepers of the loops regions or initial regions of the project. This is due to the need that the assembly of the pipe lengths should be started from a loop toward the next loop, that is, in directions B and C represented in FIG. 2, from the reference lines 15.

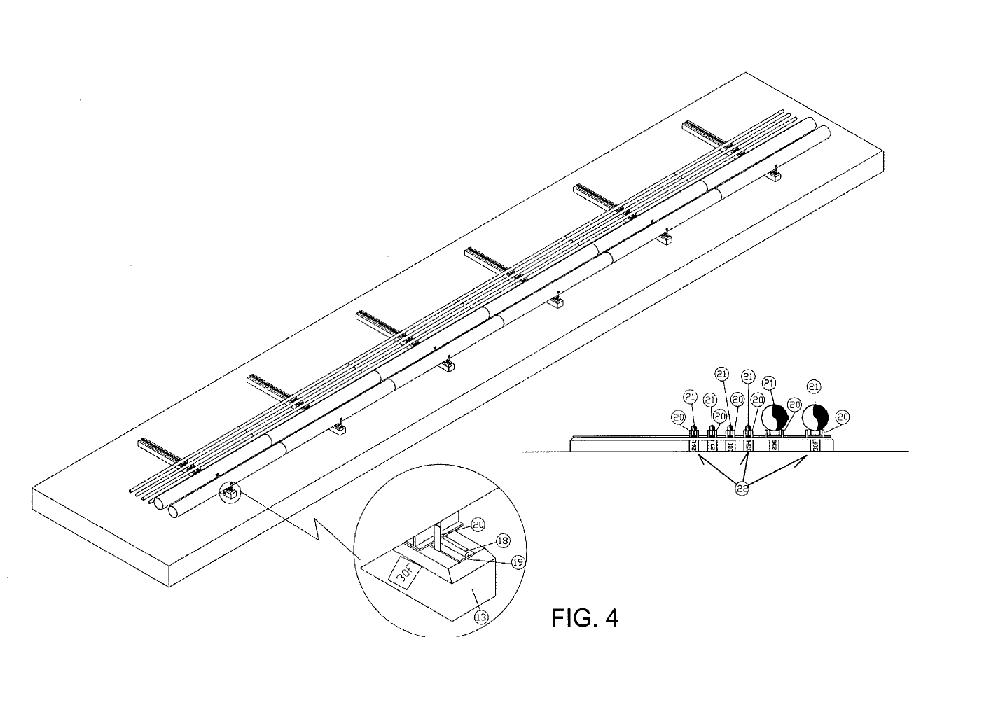

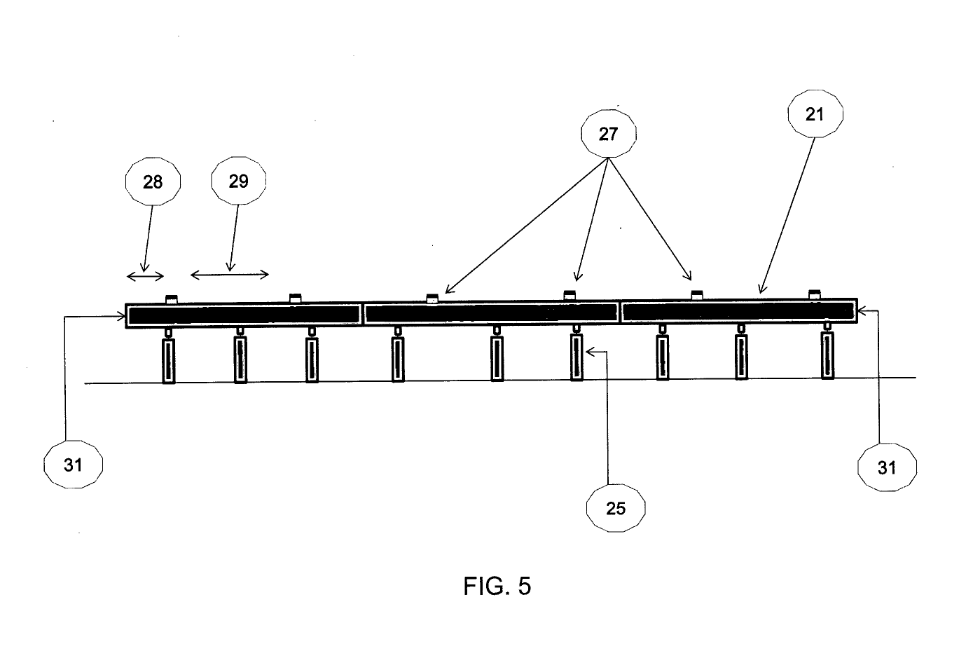

After the sleepers or support points have been built, within a priority that enables the assembly of pipe lengths as foreseen by the planning of the work, one then starts the installation of assembly guides 20, as shown in FIG. 4, which are welded onto the inserts 19 of the sleepers 13. According to the present invention, the guides are designed by the detailing engineering and may be either provisional or definitive, which is more recommended. Their sizes should achieve at least the height of the half of the tube plus ¼ of this height in the event that the support is not of the shoe type of similar, or otherwise if it fits as shoe guide so as to enable correct installation of the pipe length in its definitive position.

As a function of the size of the pipe length or tube, these guides 20 are positioned in accordance with the detailing engineering project and on a minimum of sleepers or support points necessary for obtaining a perfect alignment of the pipe lengths in their definitive positions defined by the detailing project. For instance, for a 36-meter long, it is recommended to install three guides, one at each end of the pipe length and the other approximately in the middle.

In the regions of the guides 20, in the concrete part of the sleeper, one fixes an identification that may be made by means of adhesives 22 or another similar identification means, such as a set of numbers, letters and colors, one for each type of pipe length to be assembled between determined provisional guide according to FIG. 4. Preferably, this procedure is carried out by the team that is installing the guides 20, and this identification should have with good visibility.

The same procedure should be employed in the case of supports of loops and taps.

In the same way, the pipe lengths or tubes are identified with the same identification elements externally, at the time of loading for transportation. In this way, during the unloading of a determined pipe length or tube, any doubts about its position of definitive assembly are eliminated, without the need to refer to the project documents for assembling these parts, it being enough to follow the guidance of an assembly plan.

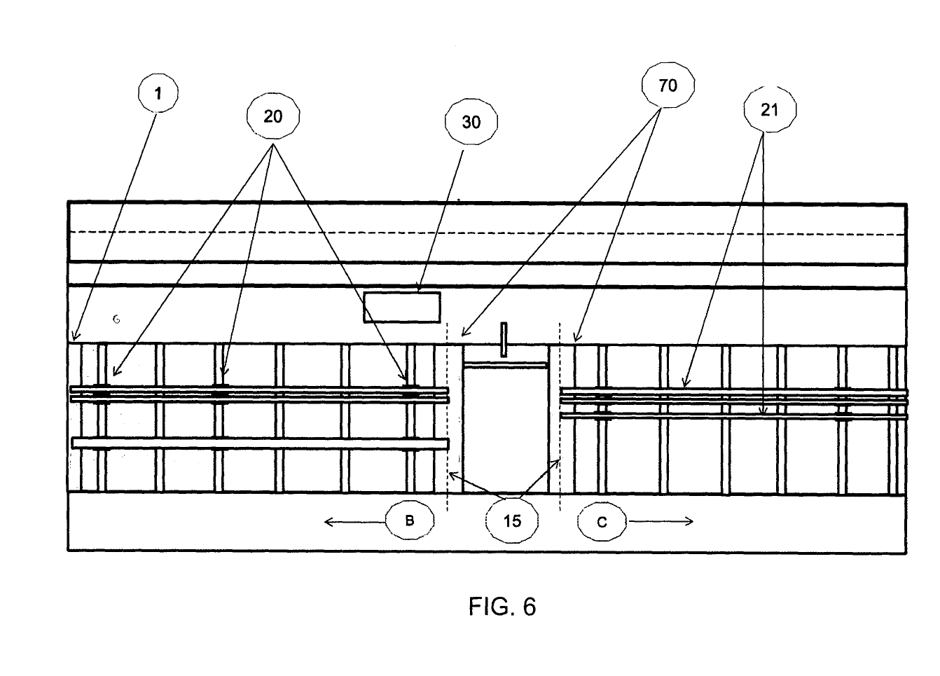

The assembly of the pipe lengths or tubes with their respective supports is started at the reference line 15, FIG. 6, in directions B and C.

By the present methodology and system for construction, fabrication and assembly of pipe, one observes that the welds for interconnection between two pipe lengths or tubes remain all aligned on a plane perpendicular to the longitudinal axis of the pipe line. In order to facilitate the coupling and the execution of these welds, one further provides a gutter 70, as shown in FIG. 3. The depth of this gutter should be informed by the detailing engineering project, and it is recommended that the distance between the gutter bottom and the lower surface of the tube should be of about 1 meter, and its width should also be of about 1 meter. This configuration may integrate the definitive project or the soil 71 may be recomposed, after completion of all the welds of its region.

In the case of threaded, flanged pipe, or one having pipe support, one proceed in the same way, so as to establish always an assembly line at the same place, preventing the dispersion of workers and facilitating the logistics, including supervision.

In the case of threaded pipe, a junction is inserted between tubes or pipe lengths, so as to provide rapid coupling between the parts, without the need to turn the pipe lengths, thus preventing damage to the painting systems of these pieces.

Once the sleepers have been built, the above-cited guides 20 positioned at place and the assembly places identified with the identification 22, one can initiate the assembly of the pipe lengths.

The pipe lengths should be carried on the transportation equipment, following the sequence of assembly thereof in the field, as determined by a Plan for Assembling Pipe Lengths.

For this purpose, one should generate Carrying Plans, following the sequence foreseen in the Plan for Assembling Pipe Lengths, using the identification 22 cited above, based on number(s)) and/or letter(s), as well as any other means suitable for such identification, by sticking the adhesive onto the outer wall of the pipe lengths.

The pipe lengths or tubes, at the time of carrying them on the transportation equipment, have their ends 31 cleaned by means of a rotary steel brush or a sanding machine. Right after this, a varnish-based coating is applied to keep the bevel edge clean, even after installation of the pipe lengths at their definitive assembly places, so as to eliminate the need for cleaning in the field, at the time of coupling between the pieces. This procedure aims at expediting the execution of a good and rapid assembly and welding with low consumption of human resources. It is recommended that the welding procedures should be qualified with utilization of said varnish, without removal thereof.

Once the transportation equipment is positioned as close as possible to the assembly place, the pipe lengths or tubes are unloaded directly between the guides 20 of FIG. 4, following the assembly sequence programmed by the planning and communicated to the assembling personal through a Plan for Assembling Pipe lengths, and considering that the transportation equipment has been loaded in accordance with this programming.

Thus, each pipe length having an outer identification composed of number(s), letter (s) and color(s) will be unloaded between the guides 20 identified in the same way.

This system for identifying pipe lengths or tubes and guides further enable greater velocity and accuracy in the operation of unloading and assembling pipe lengths or tubes in their definitive positions.

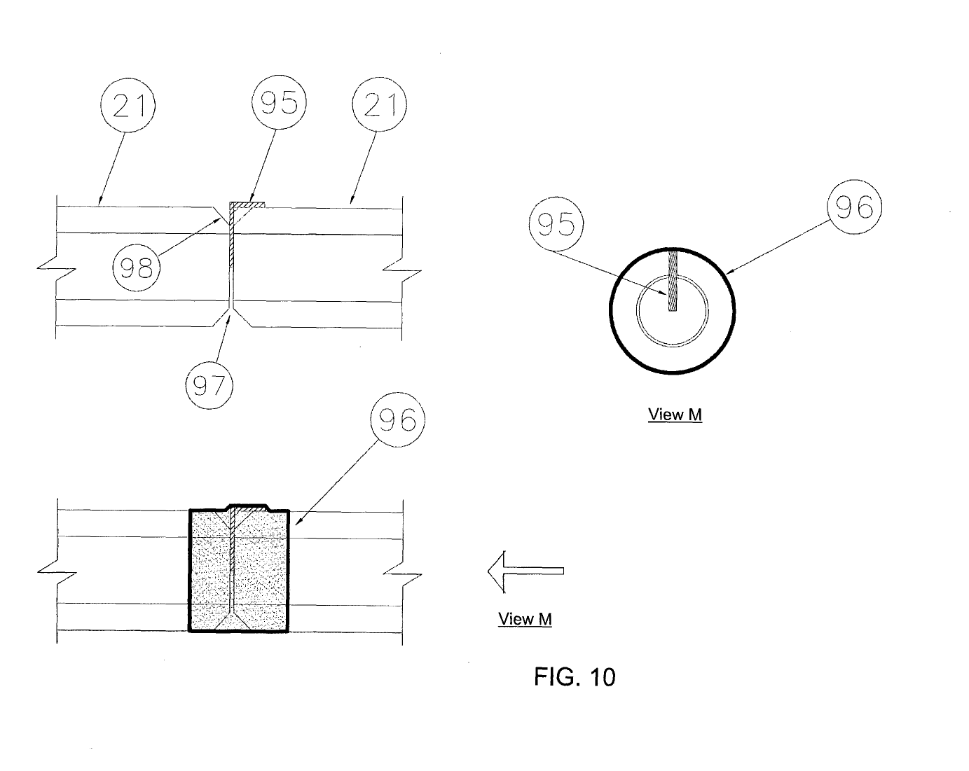

Or further, the Assembling Plan may be conceived independently of an assembly sequence, that is, all the pipe lengths of a determined area may be put at their respective places to be coupled and welded later. In this case, at the time of assembling the pipe lengths, a template 95 (FIG. 10) is inserted to obtain the opening required at the root of the joint 97 for carrying out the welding procedure specified. Then the thus constructed joint will be protected with a flexible adhesive tape 96 all around it, in order to keep the surfaces to be welded free from excess oxidation for subsequent coupling and welding.

Plans for Assembling Pipe Lengths per assembly region are further generated, with identification of the position by using a combination of number(s), letter(s) and color(s) and with identification of the assembly sequence.

Also, the welding machines and various pieces of equipment and assembling and welding devices, tools, bathroom and drinking fountain should be positioned at the same alignment where the couplings and the joints to be welded, threaded or flanged are located, according to FIG. 6, item 30.

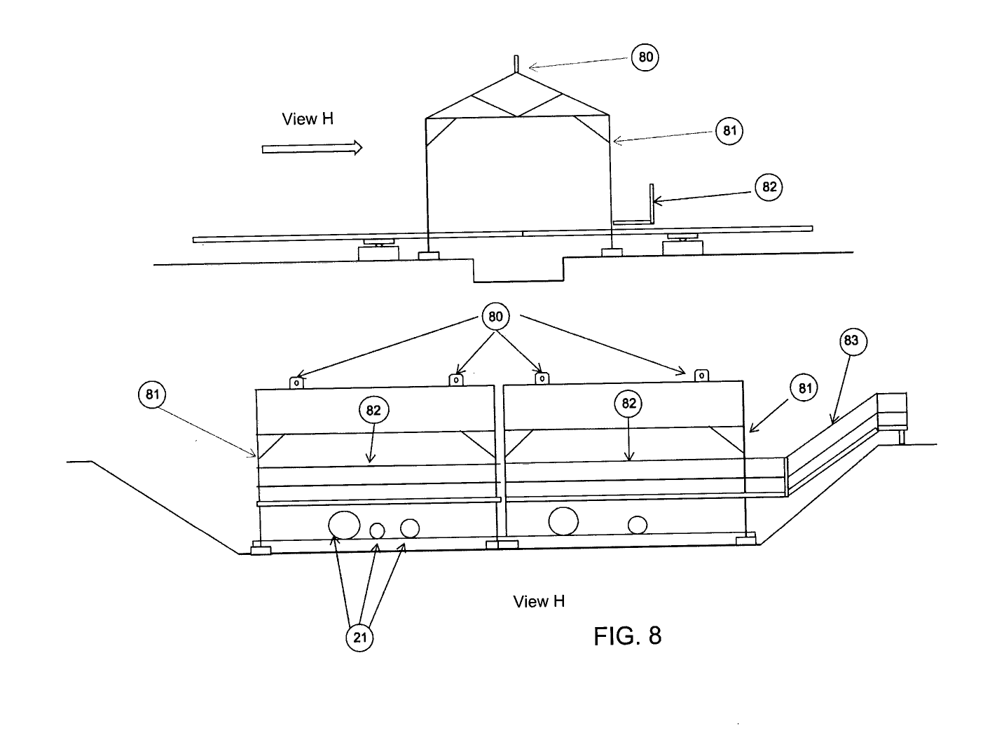

In addition, covering modules 81, FIG. 8, with their coupled passageways 82 and access staircases 83, are positioned in the line of coupling the pipe lengths or tubes, in order to achieve total protection against rain and bad-weather conditions in an extremely cost-saving manner. By the traditional method, the provision of such wide and effective protection as in the method proposed herein is unfeasible because of the spreading of welds over the field, which causes inevitable loss of resources due to stoppage of activities of assembling pipe lengths in the field.

Besides, the fact that the access to the work places at the assembly line is linked to the provision of a covering reduces the amount of scaffolding required by the traditional method, in which the welds, threads or flanges remain spread over the area with the need to build numberless accesses, including staircases and passageways. In this way, one reduces greatly the overall cost with scaffoldings in the construction and assembly of pipe.

Another advantage that results from the fact that the welds, threads or flanges remain aligned in the field lies in the ease specializing the workers for the work. For instance, a team of professionals, plumbers, welders and helpers, may specialize in coupling and welding pipe lengths and spools having a diameter of 10 (ten) inches, becoming an extremely productive team, obtaining real gain in personal availability, thus enabling the control of productivity of the professionals and contributing to reduce unproductiveness of the services in the field.

For this purpose, the team of detailing engineering project should be on the alert to project the positioning of the pipe with the same diameter, material and thickness, in a sequential manner on the sleepers or support structures of the pipe, one beside the other, whenever possible.

Also, the orderly removal of outstanding assembly activities results from the fact that the welds, threads or flanges remain aligned in the field. In this way, when one comes out of the assembly line, all the outstanding activities are eliminated, non-destructive tests are carried out, repair of painting and heat insulation are completed. All of this is done so that the team will not return to the same work place, the welding, threading or flanging have already been carried out.

One observes that, according to the present invention, the unloading and assembling activities are not different operations, as is the case traditionally, but rather a single, integrated operation, since the unloading is an activity whose immediate continuity is the positioning of the pipe lengths and spools at their definitive positions, indicated by the detailing project, following their respective coupling and welding.

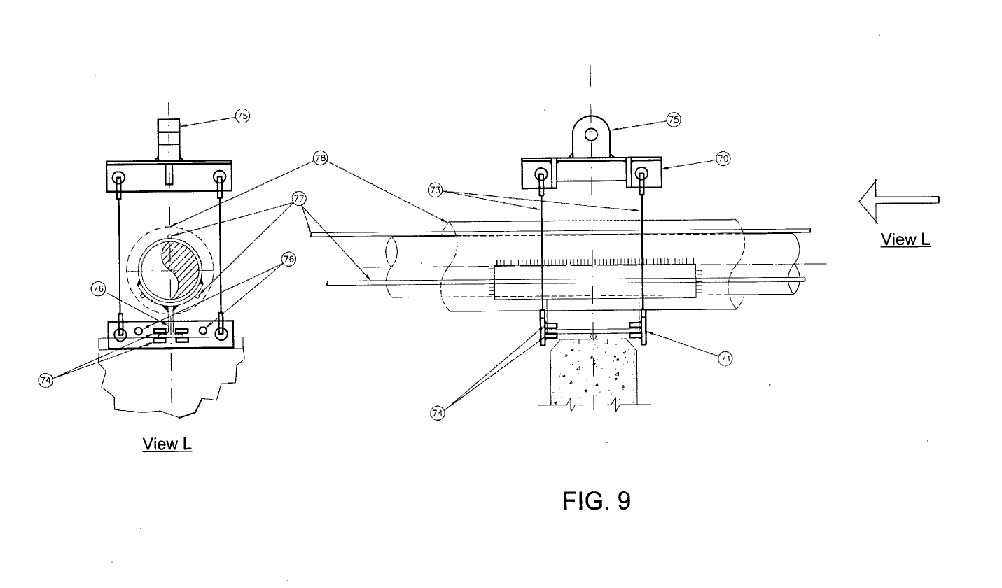

In the case of isolated pipe lengths, one may use a hoisting device that does not damage the heat insulation, as shown in FIG. 9, constituted by three parts, two lower parts 71 and one upper part 70, joined through steel ropes or another cable that can bear the load to be hoisted. The two lower parts 71 should be joined by means of case screws inserted into the bores 76. The lower parts have stops 74 for engaging the lower device 71 with the support shoe of the pipe length 76. The upper device 70 further has a hoisting eyelet 75.

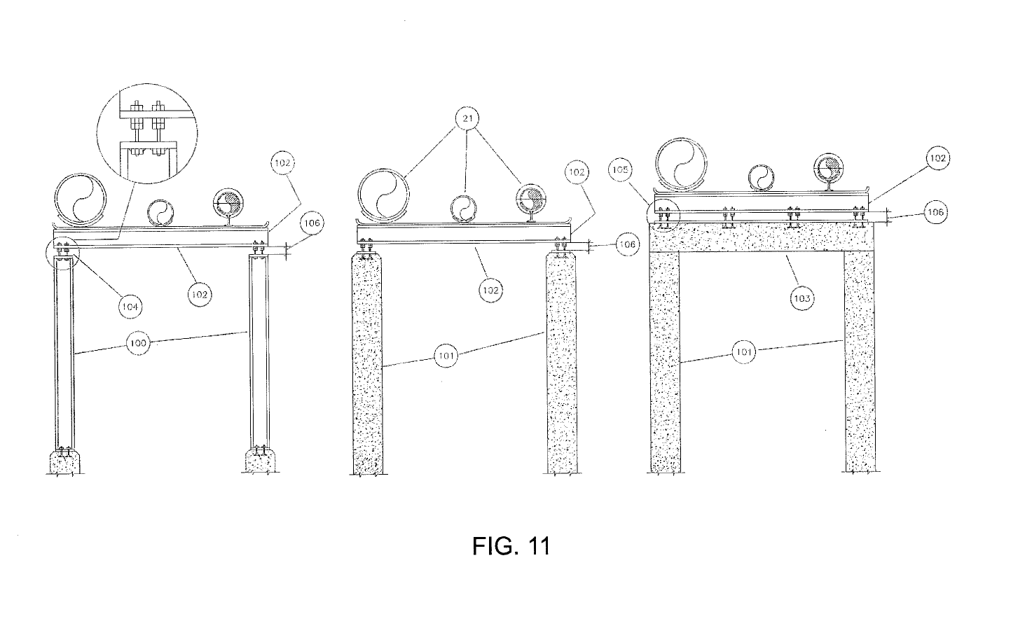

It is further possible to install support bases 102 (FIG. 11) of the supports welded onto the pipe with the level adjusting device 104 or 105, which dispenses with the above-mentioned measurements in the field, enabling the start of fabrication of three-dimensional spools even before the construction of their support.

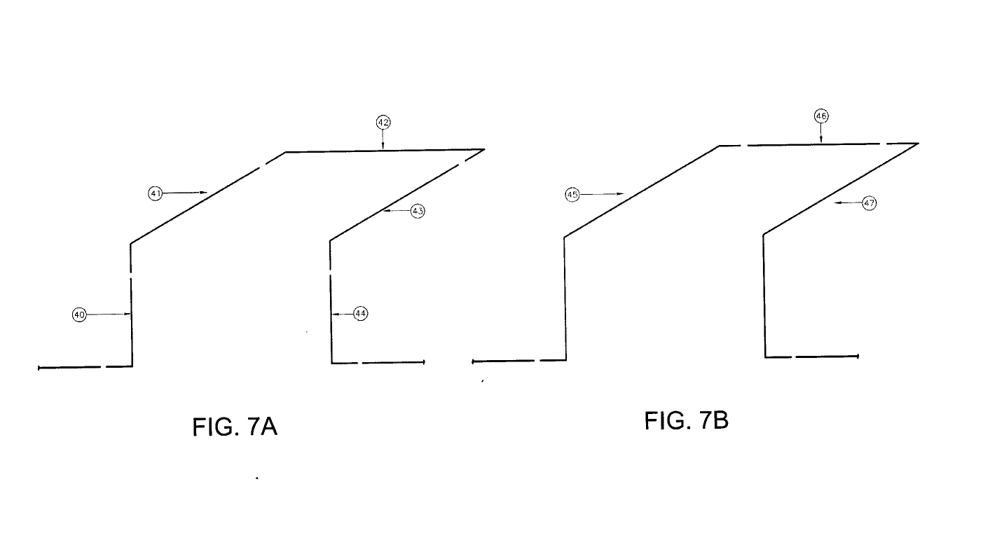

Traditionally, the set of spools of a loop has 5 (five) two-dimensional spools 40, 41, 42, 43 and 44, as shown in FIG. 7A. Thus, 6 (six) coupling and their respective welds are executed, all in the field (are of the unit), which results in much use of human resources, equipment more use of scaffolding with a high cost for carrying out these services at the place of definitive assembling.

The method and system of the present invention adopt a procedure of manufacturing three-dimensional spools in factory (out of the area of the industrial unit) 45, 46, and 47, as in FIG. 7B, significantly reducing the number of couplings and welds made in the field from 6 (six) to 4 (four). In this way, the overall costs with labor in the field are reduced, as a result also of a smaller amount of scaffoldings and equipment required.

One observes that the two-dimensional spools should be fabricationed as soon as their detailing projects are completed, inspected, jetted, painted and stocked in an areas intended for this, as it is done traditionally.

The three-dimensional spools are fabricationed in accordance with the dimensional information coming from the field and with the use of the two-dimensional spools already fabricationed and stocked as said above.

After the three-dimensional spools have been fabricationed and having the respective supports assembled and welded, their joints are inspected, examined by non-destructive tests and painted, or insulated, these spools being stored in a separate area, to wait for the moment of assembly in the field.

Or further, if one opts for the use of supports with level adjusting mechanism (104), as shown in FIG. 11, one may fabrication the three-dimensional spools at a single time, which is followed by the necessary inspections and the respective repairs of paining and/or insulation.

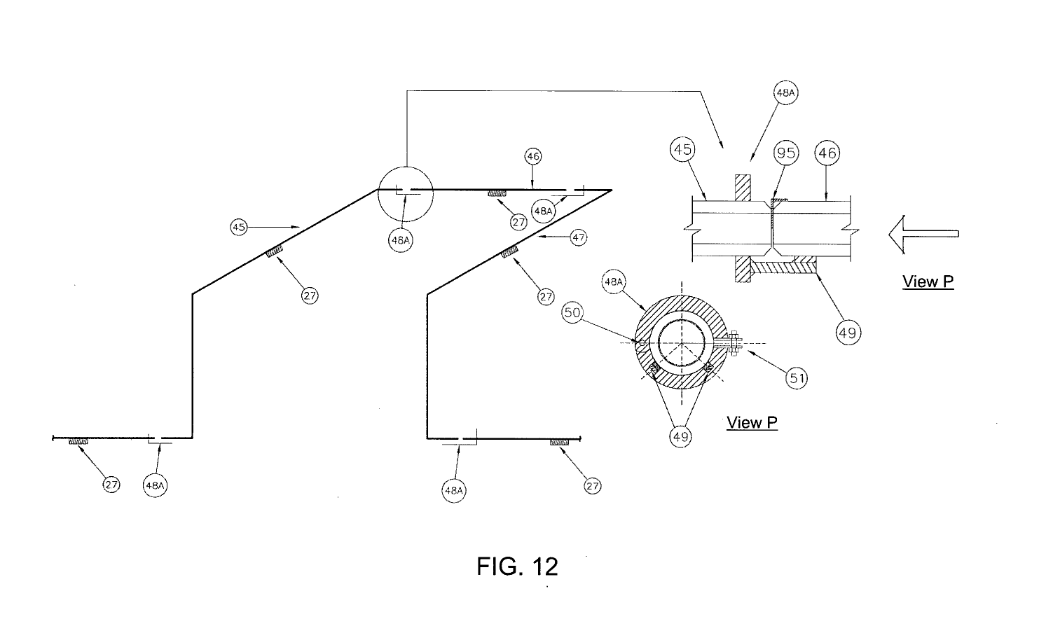

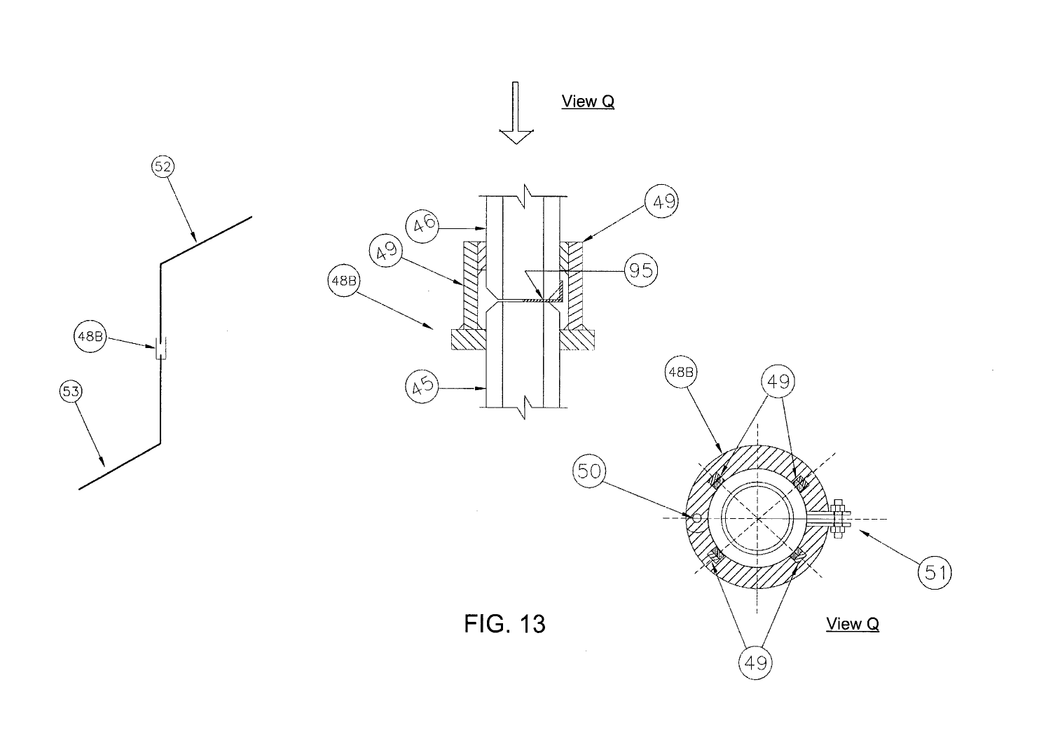

The three-dimensional or two-dimensional spools, just as the pipe lengths or tubes, are unloaded from the transportation equipment directly in their definitive positions, with the aid of the devices 48A, 48B, shown in FIGS. 12 and 13, respectively, for horizontal and vertical or inclined spools.

The devices 48A and 48B function as cradles, being support point of the spools in their assembly sequence, providing sufficient structural stability for the spools to be positioned at their definitive assembly places, awaiting their respective coupling and welding, dispensing with the additional support of load lifting machines, without the need to stock these spools in a storage area in the field away from the definitive assembly place.

It is further pointed out that the assembly of pipe lengths is made from one loop to another loop, in the two directions, as shown in FIG. 2, directions B and C, so as to made this place free as soon as possible for carrying out the dimensional procedure adopted, and thus start the fabrication of three-dimensional spools as soon as possible.

The detailing engineering should try to standardize the supports of the loops and taps, in view of the simplification of the provisional structures used in manufacturing three-dimensional spools.

A possible use of some pipe lengths with other dimensions than the one adopted as a standard does not uncharacterized the method and system of the present invention, in view of the need for dimensional closure of the project.

The present invention is based on the dimensional standardization of the pipe lengths or tubes, which are pieces belonging to the straight pipe lengths of the industrial installations, and the use of tubes with equal lengths, standardized, instead of pipe lengths (one tube welded to another) does not uncharacterized it.

Further as an extension of the conception presented, it is possible to use the method and system of the present invention for assembling standardized pipe lengths in detailing engineering projects in course or even completed, that is, although the greater benefits are achieved by adopting the methodology of standardized pipe lengths before the start of the detailing project, still significant gains will be obtained with the adoption of the present invention in detailing engineering projects already completed or in course.

With the present invention one expects to achieve a reduction of the costs of manufacturing and assembling pipe on the order of 50% and a reduction of the period of industrial undertakings using a large amount of pipe on the order of 10% to 30%, depending on the stage of the undertaking in which one decides to use the method and system proposed herein.

1-33. (canceled)

34. A method for at least one of fabrication or assembly of pipe lengths by using at least one of pipe lengths or tubes, the method comprising the steps of:
predetermining the distances between support points (13) of pipes along an assembly course of a pipe way;
providing pipes or pipe lengths with lengths which are multiples of said predetermined distances;
mounting and installing pipe supports (27) to the tubes or pipe lengths at points which are departed from each other at distances that are related to the predetermined distances; and
previously assembling and welding the pipe supports (27) onto the pipe lengths or tubes, carried out at the factory or prior to assembly of the pipe lengths or tubes at their definitive locations.

35. A method according to claim 34, wherein the fabrication of at least one of the pipe lengths or tubes occurs independently of their location of definitive installation.

36. A method according to claim 34, comprising the preparation of the ends of the pipe lengths or tubes as a function of the dimensional aspects relating to at least one from the following: chamfer or bezel, squaring the ends, designing of the openings and correcting of ovalities, which is done prior to the assembling of the tubes or pipe lengths at their definitive assembly locations.

37. A method according to claim 34, wherein the assembly of the pipe lengths or tubes is carried out by installing assembly guides (20) at the support points (13) of the pipe supports (27).

38. A method according to claim 34, wherein, in the pipe assembling procedure, identification is made at the support point of the pipe supports, to determine which pipe length or tube should be assembled at that location.

39. A method according to claim 34, wherein, in the procedure of assembling pipe lengths or tubes, these pieces are unloaded from the transportation equipment directly at the location of definitive assembly.

40. A method according to claim 34, wherein, in the procedure of assembling pipe lengths or tubes, a template (95) is introduced to guarantee the spacing (97) between the ends of the chamfers (98).

41. A method according to claim 34, wherein, in the procedure of assembling pipe, gutters (70, FIG. 3) are built in the region of the welds of the pipe lengths or tubes, perpendicular to 10 the longitudinal axis of the pipe ways, so as to facilitate the coupling and welding of these joints.

42. A method according to claim 34, comprising steps of designing the support points of the pipe supports, and of detailing the pipe, at which pipe lengths or tubes with predetermined length are used.

43. A method according to claim 34, providing a covering means (81, FIG. 8), which is modular and movable from one assembly location to another.

44. A method according to claim 43, characterized in that the covering means has a coupled staircase (83) and an access passageway (82), so as to enable access of workers to their assembling and welding locations.

45. A method according to claim 34, providing a step of installing steam tracer, which is carried out before the assembly of the predetermined pipe lengths or tubes at their definitive locations.

46. A method according to claim 34, comprising a step of applying heat insulation to the pipe lengths or tubes, which is carried out before the assembly of these pieces at their definitive locations.

47. A method according to claim 34, comprising the provision of a hoisting structure for hoisting isolated pipe lengths with or without steam tracer, which has three parts: two halves (71, FIG. 9) and one half (70), the two halves (71) being joined by means of screws (76).

48. A method according to claim 34, comprising a step of manufacturing pipe spools, which are three-dimensional and are free from additional length for adjustment at their ends.

49. A method according to claim 34, comprising a step of providing pipe support (102, FIG. 11), provided with a level adjustment device (104).

50. A system for at least one of manufacturing or assembling straight pipe lengths by using at least one of pipe lengths or tubes, the system comprising:
means for predetermining the distances between support points (13) of pipes along an assembly course of a pipe way;
means for providing pipes or pipe lengths with lengths which are multiples of said predetermined distances;
means for mounting and installing pipe supports (27) to the tubes or pipe lengths at points which are departed from each other at distances that are related to the predetermined distances; and
pipe lengths or tubes fabricated independently of their definitive installation location.

51. A system according to claim 50, wherein the ends of the tubes or pipe lengths are prepared as a function of three-dimensional aspects relating to at least one from the following: chamfer or bezel, squaring of the ends, designing of the openings and correction of ovalities before the assembly of the tubes or pipe lengths at their definitive assembly locations.

52. A system according to claim 50, wherein the pipe lengths or tubes are assembled by installing assembly guides (20) at the support points of the pipe supports.

53. A system according to claim 50, wherein the pipe support point is identified according to which pipe length or tube should be assembled at that location.

54. A system according to claim 50, wherein the pipe lengths or tubes are arranged on the transportation equipment, so that the unloading thereof will take place directly at the location of their definitive assembly.

55. A system according to claim 50, wherein a template (95) is inserted between the pipe lengths or tubes so as to guarantee the spacing (97) between ends of the chamfers (98) of these pipe lengths or tubes.

56. A system according to claim 50, wherein gutters (70) are provided in the region of welds of the pipe lengths or tubes, perpendicular to the longitudinal axis of the pipe ways, so as to facilitate the coupling or welding of these joints.

57. A system according to claim 50, wherein pipe lengths or tubes with predetermined length are used, according to the support points of the pipe supports and of pipe detailing.

58. A system according to claim 50, comprising a covering means (81, FIG. 8), which is modular and movable from one assembly location to another.

59. A system according to claim 58, characterized in that the covering means has a coupled staircase (83) and an access passageway (82), so as to enable access of workers to their assembling and welding locations.

60. A system according to claim 50, wherein a steam tracer is provided prior to assembly of the predetermined pipe lengths or tubes at their definitive locations.

61. A system according to claim 50, comprising a heat insulation on the pipe lengths or tubes, applied before the assembly of these pieces at their definitive locations.

62. A system according to claim 50, wherein a hoisting structure for hoisting isolated pipe lengths is provided with or without steam tracer, having three parts: two halves (71) and one half (70), wherein the two halves (71) are joined by screws (76).

63. A system according to claim 50, comprising three-dimensional pipe spools that are free from additional length for adjustment at their ends.

64. A system according to claim 50, wherein a pipe support (102, FIG. 11) is provided, which has an adjustment device for adjusting its level (104).

65. A device for aiding in the assembly of pipe lengths or tubes, or spools, characterized by consisting of a support 48A or 48B that may receive the ends of the pipe lengths or tubes, or spools prior to the joining of these elements.

66. A procedure for aiding in the assembly of pipe lengths or tubes, or spools, characterized in that assembly guides (20) are provided at the pipe support points, so as to enable the pipe lengths or tubes or spools to be unloaded directly at their definitive assembly locations.
